(19) United States
(12) Patent Application Publication
(10) Pub. No.: US 2003/0180056 A1
(43) Pub. Date: Sep. 25, 2003

(54) Optical receiver

(75) Inventor: Thomas Pfeiffer, Stuttgart (DE)

Correspondence Address: SUGHRUE MION, PLLC, 2100 PENNSYLVANIA AVENUE, N.W., WASHINGTON, DC, 20037, US

(73) Assignee: ALCATEL

(21) Appl. No.: 10/348,778

(22) Filed: Jan. 23, 2003

(30) Foreign Application Priority Data
Mar. 25, 2002 (EP) 02360102.4

(51) Int. Cl. H04B 10/06

(52) U.S. Cl. 398/202; 398/77

(57) ABSTRACT

It is an object of the invention to make an optical receiver for an OCDM network addressable both individually and as part of a group of optical receivers. The optical receiver according to the invention is particularly characterized in that it comprises a series combination of two optical filters having different periods. One of the periods serves to receive broadcast signals. By selecting this period at the transmitting end, a group of optical receivers each incorporating a filter with this period can be selected and a data signal can be transmitted to this group simultaneously. The other period serves to control the reception of signals individual to each receiver, with the sum and/or the difference of the two periods being used for receiving the individual signals.

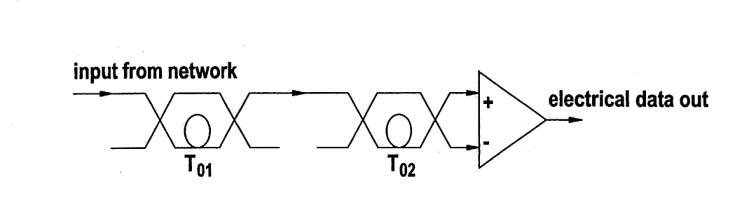

### TECHNICAL FIELD

This invention relates to an optical receiver for an OCDM network.

The invention is based on a priority application EP 02360102.4, which is hereby incorporated by reference.

### BACKGROUND OF THE INVENTION

An optical receiver generally comprises an optical filter followed by an optoelectronic detector in the form of, e.g., a differential amplifier.

Optical filters are used in optical systems, such as in OCDM, which is also referred to as OCDMA, to encode and decode optical signals, for example; OCDM=Optical Code Division Multiplexing, OCDMA=Optical Code Division Multiple Access. One type of OCDM is based on spectral encoding of broadband optical sources. The light of a light-emitting diode (LED), modulated with data to be transmitted, is passed through an optical filter, for example, and thus encoded. At the transmitting end, several such LEDs and optical filter combinations are connected e.g. via an optical coupler to an erbium-doped fiber amplifier (EDFA) which is connected to an optical fiber. In this manner, differently encoded optical signals are generated which are transmitted together over the optical fiber. Via optical splitters, transmission can take place to two or more receiving ends. Each receiving end comprises, for instance, a differential receiver with a suitable optical filter for decoding the optical signals destined for the receiving end.

An optical filter is designed, for example, as a Mach-Zehnder filter. In the Mach-Zehnder filter, the received OCDM signal is routed over two paths having complementary transfer functions. The Mach-Zehnder filter can be used to both encode and decode OCDM signals.

At the transmitting end, one optical filter is used per optical transmission channel, for example. The optical filters of different channels must be properly detuned relative to each other so as to reduce crosstalk, for example. At the receiving end, use is made of an optical filter, for example, which is tuned to the optical transmission channel intended for the receiving end. Alternatively, at the receiving end, the same number of optical filters is used as at the transmitting end. The optical filters at the receiving end are tuned to the optical filters at the transmitting end.

### SUMMARY OF THE INVENTION

It is an object of the invention to make an optical receiver for an OCDM network addressable both individually and as part of a group of optical receivers.

This object is attained by an optical receiver for an OCDM network, comprising a series combination of an optical filter arrangement and an optoelectronic detector, the optical filter arrangement having at least two different periods, with one period serving to receive broadcast or multicast signals, and the result of an algebraic operation applied to at least two periods, particularly the sum and/or the difference thereof, serving to receive individual signals.

The optical receiver according to the invention is particularly characterized in that it comprises a series combination of, e.g., two optical filters having different periods. One of the periods serves to receive broadcast or multicast signals. By selecting this period at the transmitting end, a group of optical receivers each incorporating a filter with this period can be selected and a data signal can be transmitted to this group simultaneously. The other period serves to control the reception of signals individual to each receiver. In the simplest case, the sum and/or the difference of the two periods are used for receiving the individual signals.

Through the use of a simple filter structure consisting of two optical filters, the functionality of an OCDM network can be extended in a simple manner. Within the network, groups of optical receivers can be defined to which signals can be routed both in broadcast and/or multicast mode and in individual traffic mode. Compared to the prior art, where the broadcast mode can be simulated by transmitting identical individual signals to all receivers of a group, the invention, by a single transmission in broadcast mode, saves considerable transmission capacity, e.g., 90% in the case of a group of ten receivers. The group may contain all connected optical receivers or only a part thereof. Two, three, or more groups, for example, can be formed from the entirety of the connected optical receivers.

An embodiment of the invention will now be explained with reference to the accompanying drawing.

### BRIEF DESCRIPTION OF THE DRAWINGS

The single FIGURE shows an optical receiver in accordance with the invention. The receiver comprises a series combination of a first optical filter, a second optical filter, and an optoelectronic detector, the two optical filters having different periods, one of the periods serving to receive broadcast signals, and the sum and/or the difference of the two periods serving to receive individual signals.

### BEST MODE FOR CARRYING OUT THE INVENTION

The optical filters are designed as Mach-Zehnder filters, for example. The optoelectronic detector is designed as optoelectronic differential amplifier, for example.

The optical receiver is characterized by the following transfer function:

$${ΔH}_{Rx} ( v ) = \frac{1}{2} \{ cos [ 2 π v {T}_{02} ] + \frac{1}{2} cos [ 2 π v ( {T}_{01} - {T}_{02} ) ] + \frac{1}{2} cos [ 2 π v ( {T}_{01} + {T}_{02} ) ] \}$$

where T₀₁ and T₀₂ correspond to the periods of the optical filters, with T₀₂ serving to receive broadcast or multicast signals, and T₀₁+T₀₂ and/or T₀₁−T₀₂ serving to receive individual signals. The transfer function is the effective receiver filter function, which already includes the optoelectronic detector. In the broadcast and multicast modes, use is made of the first cosine term; during individual reception, the second term and/or the third term are used. At the transmitting end, an optical filter with period T₀₂ is employed for broadcast mode; for multicast mode, a number of optical filters with different periods T₀₂, T_{02′}, T_{02″}, etc. are used; and for the individual traffic mode, an optical filter with period T₀₁+T₀₂ and an optical filter with period T₀₁−T₀₂ or an optical filter with both terms are used.

The optical receiver is incorporated into an OCDM network. Such an OCDM network will comprises, for instance, at least one optical transmitter and at least two optical receivers in accordance with the invention, which are interconnected by optical fibers, with at least two of the optical receivers each having one filter with the same period and one filter with an individual period. The optical receivers of a group thus comprise a first optical filter whose period is equal to the period of the first optical filters of the other optical receivers. Furthermore, all optical receivers include a second optical filter whose period is individual to each optical receiver. The series combination of the first and second optical filters may also be referred to as a cascade connection.

Both broadcast signals and multicast signals serve, for instance, signaling, TV signal transmission, and/or network management purposes. Individual signals may also be referred to as unicast signals and serve, for example, to transmit Internet data and/or telephone signals.

The optical receiver in accordance with the invention permits a simple implementation. An optical filter with period T₀₂ and an optoelectronic detector can be integrated onto a single chip, such as a hybrid integrated circuit chip, since the period T₀₂ is the same for all optical receivers of a group. This makes it possible to optimize the signal level and the delay on the link between optical filter and optoelectronic detector by an appropriate design. The optical filter with individual and adjustable period T₀₁ completes the optical receiver. Thus, low-cost optical receivers can be manufactured which are suitable for mass production.

In an exemplary development, the free spectral ranges (FSRs) of the first and second optical filters differ by at least a factor of ten. FSR is defined via the period T0=1/FSR. The first and second optical filters are designed, for example, as filters with periodic transfer function, e.g. as FIR or IIR filters. The first optical filter is, for instance, a Mach-Zehnder filter or a Fabry-Perot filter, and the second optical filter is, for instance, a Mach-Zehnder filter.

In the embodiment, the number of filters or at least of filter functionalities in an optical receiver according to the invention is two. Instead of two optical filters, three or more optical filters may be connected in series in an optical receiver according to the invention. In the case of three filters, the first will serve, for example, to receive broadcast signals, which are destined for all optical receivers; the second filter will serve to receive multicast signals, which are destined for a group of optical receivers; and the third filter or its period, in an algebraic combination with one or both periods of the first filter and/or second filter, will serve to receive individual signals.

1. An optical receiver for an OCDM network, comprising a series combination of an optical filter arrangement and an optoelectronic detector, the optical filter arrangement having at least two different periods, with one period serving to receive broadcast or multicast signals, and the result of an algebraic operation applied to at least two periods, particularly the sum and/or the difference thereof, serving to receive individual signals.

2. An optical receiver as set forth in claim 1, wherein the optical filter arrangement comprises a series combination of at least two optical filters, at least two of which have different periods, with one period serving to receive broadcast or multicast signals, and the result of an algebraic operation applied to at least two periods, particularly the sum and/or the difference thereof, serving to receive individual signals.

3. An optical receiver as set forth in claim 1, with the following transfer function:
$${ΔH}_{Rx} ( v ) = \frac{1}{2} \{ cos [ 2 π v {T}_{02} ] + \frac{1}{2} cos [ 2 π v ( {T}_{01} - {T}_{02} ) ] + \frac{1}{2} cos [ 2 π v ( {T}_{01} + {T}_{02} ) ] \}$$
where T₀₁ and T₀₂ correspond to the two periods of an optical filter arrangement comprising two optical filters, with T₀₂ serving to receive broadcast or multicast signals, and T₀₁+T₀₂ and/or T₀₁−T₀₂ serving to receive individual signals.

4. An optical receiver as set forth in claim 1, wherein the optical filter arrangement comprises a series combination of three optical filters having three different periods, a first period serving to receive broadcast signals, a second period serving to receive multicast signals, and the result of an algebraic operation applied to a third period and the first period and/or the second period serving to receive individual signals.

5. An optical receiver as set forth in claim 1, wherein the optoelectronic detector is designed as an optoelectronic differential amplifier.

6. An OCDM network comprising at least one optical transmitter and at least two optical receivers as set forth in claim 1 which are interconnected by optical fibers, at least two of the optical receivers each comprising a filter arrangement with the same period and a filter arrangement with at least one individual period.
